(19) United States
(12) Patent Application Publication
(10) Pub. No.: US 2011/0205850 A1
(43) Pub. Date: Aug. 25, 2011

(54) SYSTEM AND METHOD FOR MANAGING CALENDAR EVENTS USING LOCATION INFORMATION

(76) Inventors: Srinivas Annambhotla, Cary, NC (US); Muralimohan Gopalakrishna, Morrisville, NC (US)

(21) Appl. No.: 12/710,740

(22) Filed: Feb. 23, 2010

(51) Int. Cl. G04B 47/00

(52) U.S. Cl. 368/14

(57) ABSTRACT

To enhance calendar functionality, location tracking may be used to draw an inference that a calendar event has been satisfied. Upon the inferred satisfaction of the calendar event, a status of the calendar event may be updated from “outstanding” to “completed.” If the calendar event is shared with another person, a message may be transmitted to an electronic device of the other individual to alert that person to the completion of the calendar event. Location tracking may include identifying that an electronic device moves toward a location associated with the calendar event, identifying that the electronic device comes to a relative stop within a predetermined distance of the location associated with the calendar event, and departs the location associated with the calendar event.

### TECHNICAL FIELD OF THE INVENTION

The technology of the present disclosure relates generally to electronic devices and, more particularly, to a system and method for managing shared calendar entries using location tracking of an electronic device.

### BACKGROUND

Personal information manager (PIM) calendar applications are available for portable electronic devices. PIM calendar applications may use location information to identify the location of a calendar event, such as an appointment having a specified place and a specified time. Location information for the electronic device may be ascertained using, for example, global positioning system (GPS) data. These applications are intended to assist a user reach a destination for an appointment in a timely manner. For instance, the application may alert the user to an estimated travel time from a current location to the location associated with the appointment. When the electronic device, and presumably the user, reaches the location for the appointment, the application begins to process estimated travel time to the next event in the calendar. In addition, some calendar applications allow the user to share calendar events with other people to coordinate the accomplishment of tasks or coordinate the scheduling of calendar events.

But conventional calendar applications are deficient in the mechanisms used to identify that a task related to a calendar event is complete and alert a shared user to the accomplishment of the task. As an example, it will be assumed that Alice and Bob are the parents of a school-aged boy, Ricky. It is the shared responsibility of Alice and Bob to pick-up Ricky from school. Alice and Bob use a shared family calendar to track various events, such as school pick-ups, the times and places of Ricky' soccer practices and games, parent-teacher association (PTA) meetings, doctor appointments, and other events related to members of the family.

For purposes of an example, Bob may have responsibility for a calendar event to pick-up Ricky from school on the current day. It will further be assumed that Bob becomes unavailable to attend to this calendar event due to work responsibilities and attempts to transfer responsibility for the task to Alice (e.g., by sending a text message, by updating the calendar, by leaving Alice a voice message, and/or by other techniques). In the example, Bob does not receive confirmation from Alice that she will undertake the task. He may even call Alice while she is driving to Ricky's school, but she may not answer or return his call while driving. In this scenario, Bob may become unnecessarily anxious that Ricky will not be pick-up from school in a timely manner.

### SUMMARY

To enhance calendar functionality, location tracking may be used to draw an inference that a calendar event has been satisfied. Upon the inferred satisfaction of the calendar event, a status of the calendar event may be updated from “outstanding” (or other indication of not completed) to “completed” (or other indicator that the event is satisfied). If the calendar event is shared with another person, a message may be transmitted to an electronic device of the other individual to alert that person to the completion of the calendar event. Location tracking may include identifying that an electronic device moves toward a location associated with the calendar event, identifying that the electronic device stops within a predetermined distance of the location associated with the calendar event, and departs the location associated with the calendar event.

According to one aspect of the disclosure, a portable electronic device includes a receiver over which location data is received; and a control circuit configured to: track travel of the electronic device using the location data; and correlate the travel of the electronic device to a calendar event and, if the travel indicates satisfaction of the calendar event, determine by inference that the calendar event is satisfied.

According to one embodiment of the portable electronic device, the travel that indicates satisfaction of the calendar event occurs within a predetermined period of time from a time associated with the calendar event.

According to one embodiment of the portable electronic device, the travel that indicates satisfaction of the calendar event occurs within a predetermined distance from a location associated with the calendar event.

According to one embodiment of the portable electronic device, the control circuit is further configured to mark the calendar event as complete when the inference that the calendar event is satisfied is made.

According to one embodiment of the portable electronic device, the control circuit is further configured to generate and transmit a message to another electronic device associated with a user that subscribes to share the calendar event to alert the user to completion of the calendar event.

According to one embodiment of the portable electronic device, travel that indicates satisfaction of the calendar event includes: movement of the portable electronic device toward a location associated with the calendar event; and a relative stop in motion of the portable electronic device at or near the location associated with the calendar event.

According to one embodiment of the portable electronic device, travel that indicates satisfaction of the calendar event further includes movement of the portable electronic device away from the location associated with the calendar event following the relative stop in motion.

According to another aspect of the disclosure, a method of managing calendar events in a portable electronic device includes tracking travel of the electronic device; correlating the travel of the electronic device to a calendar event; and determining that the calendar event is complete if the travel indicates satisfaction of the calendar event.

According to one embodiment of the method, the travel that indicates satisfaction of the calendar event occurs within a predetermined period of time from a time associated with the calendar event.

According to one embodiment of the method, the travel that indicates satisfaction of the calendar event occurs within a predetermined distance from a location associated with the calendar event.

According to one embodiment, the method further includes marking the calendar event as complete when the determination that the calendar event is complete is made.

According to one embodiment, the method further includes generating and transmitting a message to another electronic device associated with a user that subscribes to share the calendar event to alert the user to completion of the calendar event.

According to one embodiment of the method, travel that indicates satisfaction of the calendar event includes: movement of the portable electronic device toward a location associated with the calendar event; and a relative stop in motion of the portable electronic device at or near the location associated with the calendar event.

According to one embodiment of the method, travel that indicates satisfaction of the calendar event further includes movement of the portable electronic device away from the location associated with the calendar event following the relative stop in motion.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a communication system having exemplary electronic devices configured to manage shared calendar events using location information; and

FIGS. 2 and 3 are flow charts representing an exemplary method of managing shared calendar events.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, an electronic navigator (e.g., a “GPS device”), a media player, a gaming device, a computer, a pager, a communicator, an electronic organizer, a personal digital assistant (PDA), etc.

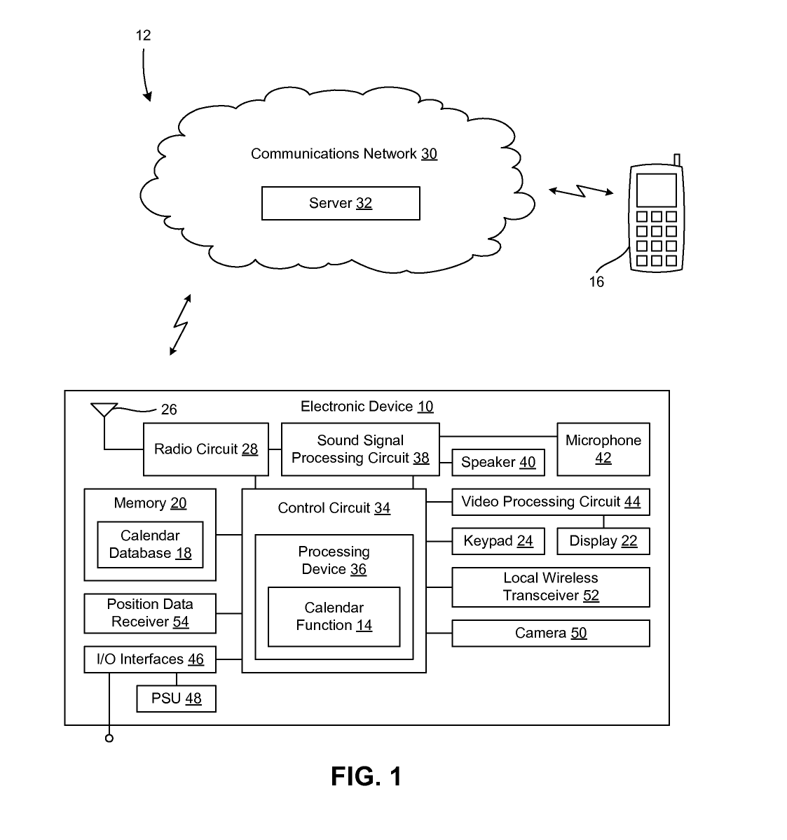

Referring initially to FIG. 1, an electronic device 10 that forms part of a communications system 12 is shown. The electronic device 10 may include a calendar functions 14 that is configured to share information about calendar events with another electronic device 16 that also forms part of the communication system 12. In one embodiment, the calendar events (also referred to as calendar entries) may be stored in a calendar database 18 that is resident in one or both of the electronic devices 10 and 16. The calendar function 14 may be implemented to track and manage calendar events for a user of the electronic device 10, such as appointments, meetings, and scheduled tasks. One or more of the calendar events may be shared with the user of the electronic device 16. Shared users of a calendar event may be referred to as subscribers to the calendar event. For shared calendar events, corresponding reminders for the calendar events may be generated for each user.

In addition, the calendar function 14 may be configured to track the travel of the electronic device 10 and, when tracked travel indicates completion of a calendar event, then the calendar function 14 may make a determination that user behavior to complete the calendar event has occurred. In that event, the calendar event may be marked as completed and a message indicating that the calendar event is complete may be transmitted to the electronic device 16 corresponding to the shared user of the calendar event. Additional details of these functions will be described in greater detail below.

The calendar function 14 may be embodied as executable instructions (also referred to as code, software, or a program) that is resident in and executed by the electronic device 10. In one embodiment, the calendar function 14 may be one or more programs that are stored on a computer readable medium, such as in the form of a memory 20. The calendar function 14 may be a stand-alone software application or form a part of a software application that carries out additional tasks related to the electronic device 10.

The calendar database 18 also may be stored on a computer readable medium, such as in the form of the memory 20. As indicated, the calendar database 18 may store data that is used by the calendar function 14, including information regarding calendar events. Information regarding calendar events may include, for example, a date and time at which the calendar event is scheduled to occur, a place at which the calendar event is scheduled to occur, and any shared users. Contact information for shared users for the purpose of sending a message may be stored as part of the calendar event or may be accessible from a contact list database. The time at which a calendar event is scheduled to occur may be specified as a point in time (e.g., 8:30 am) or as a block of time (e.g., from 4:00 pm to 5:00 pm).

An exemplary configuration for the electronic device 10 now will be described. The electronic device 16 may be configured in a similar manner. The electronic device 10 may include a display 22. The display 22 displays information to a user such as operating state, time, telephone numbers, contact information, various menus, etc., that enable the user to utilize the various features of the electronic device 10. The display 22 also may be used to visually display content to a user, such as photographs, mobile television content, Internet pages, and video. In addition, calendar screens and calendar events may be displayed on the display 22.

The electronic device 10 may include one or more user inputs. For example, a keypad 24 may include alphanumeric keys for allowing entry of alphanumeric information (e.g., telephone numbers, phone lists, contact information, notes, text, etc.) and/or special function keys (e.g., a select key, a call send and answer key, multimedia playback control keys, a camera shutter button, etc.). A navigation or pointing device also may be present. In addition to keys or instead of keys, input functionality may be embodied as a touch screen associated with the display 22. Also, the display 22 and keypad 24 may be used in conjunction with one another to implement soft key functionality.

The electronic device 10 includes communications circuitry that enables the electronic device 10 to establish communications with another device, such as the device 16. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., high speed packet access (HSPA), for which the 3rd generation partnership project (3GPP) has issued standards, long term evolution (LTE), a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., calendar events, image files, video files, audio files, ring tones, Internet content, etc.), receiving or sending messages (e.g., text messages, instant messages, electronic mail messages, multimedia messages, etc.), and so forth. This data may be processed by the electronic device 10, including storing the data in the memory 20, executing applications to allow user interaction with the data, displaying video and/or image content associated with the data, outputting audio sounds associated with the data, and so forth.

In the exemplary embodiment, the communications circuitry may include an antenna 26 coupled to a radio circuit 28. The radio circuit 28 includes a radio frequency transmitter and receiver for transmitting and receiving signals via the antenna 26.

The radio circuit 28 may be configured to interact with a communications network 30. Radio circuit 28 types for interaction with a mobile radio network and/or broadcasting network include, but are not limited to, global system for mobile communications (GSM), code division multiple access (CDMA), wideband CDMA (WCDMA), general packet radio service (GPRS), HSPA, LTE, WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 26 and the radio circuit 28 may represent one or more than one radio transceiver.

The communications network 30 may include a server 32 (or servers) for managing calls placed by and destined to the electronic device 10, transmitting data to and receiving data from the electronic device 10, and carrying out any other support functions. The server 32 communicates with the electronic device 10 via a transmission medium. The transmission medium may be any appropriate device or assembly, including, for example, a communications base station (e.g., a cellular service tower, or “cell” tower), a wireless access point, a satellite, etc. The network 30 may support the communications activity of multiple electronic devices 10 and other types of end user devices. In alternative arrangements, the electronic device 10 may wirelessly communicate directly with another electronic device (e.g., another mobile telephone or a computer) through a local network or without an intervening network.

The electronic device 10 may include a primary control circuit 34 that is configured to carry out overall control of the functions and operations of the electronic device 10. The control circuit 34 may include a processing device 36, such as a central processing unit (CPU), microcontroller or microprocessor. The processing device 36 executes code stored in a memory (not shown) within the control circuit 34 and/or in a separate memory, such as the memory 20, in order to carry out operation of the electronic device 10. For instance, the memory within the control circuit 34 and/or the memory 20 may store executable code that embodies the calendar function 14 and the processing device 36 may execute that code so that the control circuit 34 is configured to implement the functions of the calendar function 14. The memory 20 and/or any memory of the control circuit 34 may include one or more types of memory components. For example, memory of the electronic device 10 may be one or more of a buffer, a flash memory, a hard drive, a removable media, a volatile memory, a non-volatile memory, a random access memory (RAM), or other suitable device. In one arrangement, the memory 20 may include a non-volatile memory for long term data storage and a volatile memory that functions as system memory for the control circuit 34. The memory 20 may exchange data with the control circuit 34 over a data bus. Accompanying control lines and an address bus between the memory 20 and the control circuit 34 also may be present.

The electronic device 10 further includes a sound signal processing circuit 38 for processing audio signals. Coupled to the sound processing circuit 38 are a speaker 40 and a microphone 42 that enable a user to listen and speak via the electronic device 10 during a call. Audio corresponding to music files, video files, and other audio sources also may be output via the speaker 40. Audio data may be passed from the control circuit 34 to the sound signal processing circuit 38 for playback to the user. Similarly, audio signals generated by the microphone 42 may be input to the sound signal processing circuit 38. The sound signal processing circuit 38 may include any appropriate buffers, decoders, encoders, amplifiers, and so forth.

The display 22 may be coupled to the control circuit 34 by a video processing circuit 44 that converts video data to a video signal used to drive the display 22. The video processing circuit 44 may include any appropriate buffers, decoders, video data processors, and so forth.

The electronic device 10 may further include one or more input/output (I/O) interface(s) 46. The I/O interface(s) 46 may be in the form of typical mobile telephone I/O interfaces and may include one or more electrical connectors for serving as data ports that connect the electronic device 10 to another device (e.g., a computer) or an accessory (e.g., a personal handsfree (PHF) device) via a cable. Further, operating power may be received over the I/O interface(s) 46 and power to charge a battery of a power supply unit (PSU) 48 within the electronic device 10 may be received over the I/O interface(s) 46. The PSU 48 may supply power to operate the electronic device 10 in the absence of an external power source.

The electronic device 10 also may include various other components. A camera 50 may be present for taking digital pictures and/or movies. In a camera mode, the display 22 may function as an electronic viewfinder. Image and/or video files corresponding to the pictures and/or movies may be stored in the memory 20. A local transceiver 52, such as an RF transceiver (e.g., a Bluetooth chipset), may be used to establish communication with a nearby device, such as an accessory (e.g., a wireless PHF device), another mobile radio terminal, a computer, or another device.

The electronic device 10 may be configured to receive location information that identifies the location of the electronic device 10 or may be configured to determine the location of the electronic device 10 from received information. For instance, the electronic device 10 may be equipped with a position data receiver 54, such as a global positioning system (GPS) receiver. Data received with the position data receiver 54 may be used to determine the location of the electronic device 10 as will be understood in the art. In one embodiment, assisted GPS (AGPS) may be used to offload some of the processing tasks involved in location determination to an assistance server. Another embodiment may involve receiving location information from an external location tracking device, such as a GPS device that is built into a vehicle.

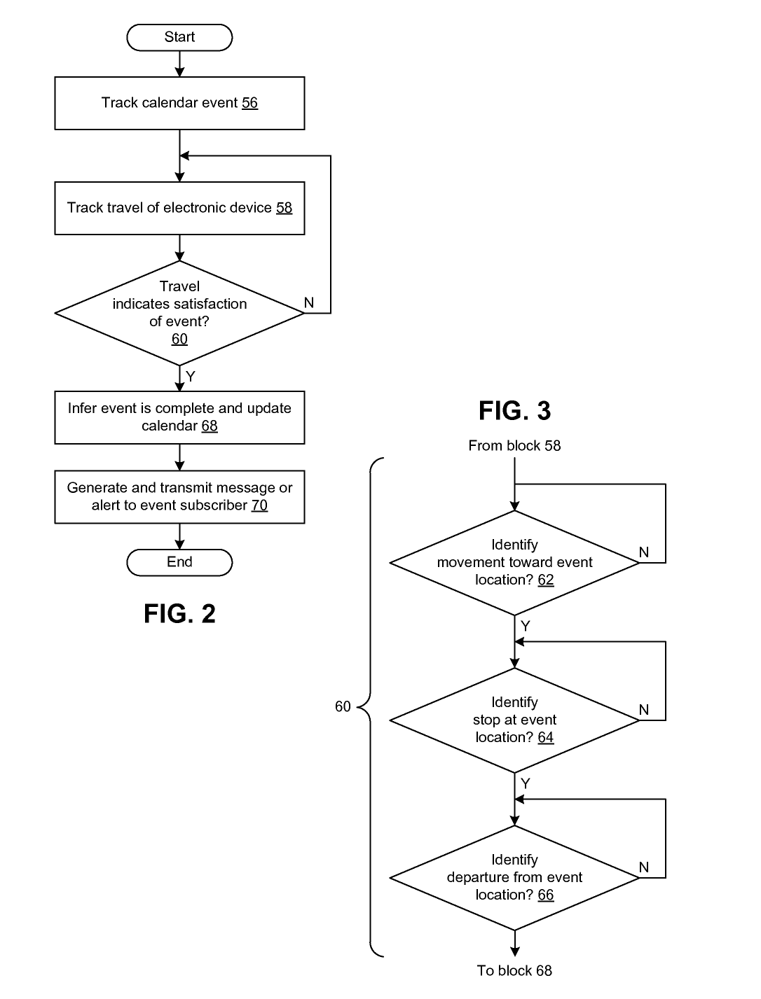

With additional reference to FIG. 2, illustrated are logical operations to implement an exemplary method of managing calendar events using location information. The exemplary method may be carried out by executing an embodiment of the calendar function 14, for example. Thus, the flow chart of FIG. 2 may be thought of as depicting steps of a method carried out by the electronic device 10. Although FIG. 2 shows a specific order of executing functional logic blocks, the order of executing the blocks may be changed relative to the order shown. Also, two or more blocks shown in succession may be executed concurrently or with partial concurrence. Certain blocks also may be omitted.

The logical flow may begin in block 56 where one or more calendar events are tracked with the calendar function 14. The tracked calendar event(s) may be the next chronologically scheduled event and/or a calendar event having an associated time that has passed. As indicated, the calendar event may have an associated time and location, and may be shared with the user of the other electronic device 16. For purposes of an example, the example from the background section will be continued where Bob has requested Alice to satisfy the shared calendar event of picking up their son, Ricky, from school. For purposes of an exemplary description, the task of picking up Ricky will be considered a scheduled appointment, or calendar event, that is tracked in block 56. It will be appreciated that the techniques described in this disclosure have application in contexts other than shared family calendar events. For instance, the techniques may be used for tracking employees, tracking deliveries, and any other appropriate situation.

Also tracked, in block 58, is travel of the electronic device 10. It will be assumed that the electronic device 10 travels with the corresponding user. Therefore, progressive location changes of the electronic device 10 will serve as an indicator of the travel of the user. Location of the electronic device 10 may be determined using any appropriate technique, including using received GPS data. Location also may be determined from information provided by the network 30. A series of location determinations may be used to identify travel toward a predetermined location (e.g., the location associated with the tracked calendar event), a stop at the predetermined location, and travel away from the predetermined location. It is possible that the movement tracking of block 58 will not commence until the actual time is within the predetermined amount of time from the tracked calendar event.

Next, in block 60, a determination may be made as to whether the movement of the electronic device 10 indicates satisfaction of the tracked calendar event. In one embodiment, the movement to satisfy the event must occur within a predetermined amount of time from (i.e., before or after) the time associated with the tracked calendar event. In this manner, movement of the electronic device 10 at a time unrelated to the calendar event will not indicate satisfaction of the event. For instance, if Alice were to drop Ricky off at school in the morning, her movement at that time will not indicate satisfaction of picking Ricky up from school in the afternoon. The predetermined amount of time may be set by default, may depend on the type of event, may depend on how far the electronic device 10 is from the location associated with the event, or may be user configurable. The predetermined amount of time may be, for example, 5 minutes, 10 minutes, 15 minutes, 30 minutes, one hour, or some other amount of time from the scheduled time associated with the event. If the event is associated with a block of time, the predetermined amount of time may be measured from either of the start time or the end time, or measured from both the start time and the end time to create a window of time surrounding the event's block of time.

Movement of the electronic device 10 that indicates satisfaction of the tracked calendar event may take any appropriate form. For example, presence of the electronic device 10 at the location associated with the calendar event may produce a positive result. In one embodiment, a series of identifiable movements may be used to generate a positive result.

With additional reference to FIG. 3, an exemplary embodiment of sub-steps for block 60 is illustrated. In block 62, a determination may be made as to whether the electronic device 10 approaches, or travels toward, the location associated with the calendar event. Upon a positive determination in block 62, the logical flow may proceed to block 64. In block 64, a determination may be made as to whether the electronic device 10 stops at the location associated with the calendar event. Stopping at the event may include, for a predetermined amount of time, a complete stoppage in movement, a pause in relative movement, or relatively slow movement in the location. The predetermined amount of time to detect stoppage of movement may be set by default, may depend on the type of event, or may be user configurable. The predetermined amount of time may be several seconds, a half minute, a minute, five minutes, or some other amount of time. In the case of a calendar event that is associated with a block of time, the predetermined amount of time may be a percentage of the length of the block of time.

In addition, the location of the stoppage need not precisely match the location associated with the calendar event. Rather, the stoppage may occur within a predetermined distance of the location, such as a distance of less than a tenth of a mile (e.g., less than about 0.2 kilometers), a distance of about 100 yards (e.g., about 100 meters), a distance of about 50 yards (e.g., about 50 meters), a distance of about 10 yards (e.g., about 10 meters), or some other distance. For example, if the event to pick-up Ricky at school has a location associated with the front door of the school or a precise street address, then a stop may not be registered if Alice does not stop at that exact location. Alice may instead stop at a student pickup location, a parking lot, or some other location associated with the school. In these situations, using a tolerance for the location may improve performance of the calendar function 14. The tolerance amount may be configurable by the user.

Upon a positive determination in block 64, the logical flow may proceed to block 66. In block 66, a determination may be made as to whether the electronic device 10 departs (e.g., moves away from) the location associated with the calendar event.

Upon a positive determination in block 60, which may be a positive determination in block 66 where the embodiment of FIG. 3 is employed, the logical flow may proceed to block 68. In block 68, an inference may be made that the task or other objective of the calendar event has been performed, thereby resulting in a determination that the calendar event is satisfied. The calendar event may be updated to have a competed status. Then, in block 70, a message may be generated and transmitted to the electronic device 16 of the shared user for the calendar event. The message may be in any appropriate form to indicate to the shared user that the shared calendar event has been completed. For instance, the message may be one or more of a text message, an instant message, an electronic mail message, an alert, a calendar update, or other notification.

As will be appreciated, the completion of calendar events may be identified with little or no intervention by the user of the electronic device 10. Furthermore, a user of another electronic device that is a subscriber to the calendar event may be alerted to the completion of the calendar event.

Although certain embodiments have been shown and described, it is understood that equivalents and modifications falling within the scope of the appended claims will occur to others who are skilled in the art upon the reading and understanding of this specification.

What is claimed is:

1. A portable electronic device, comprising:
a receiver over which location data is received; and
a control circuit configured to:
track travel of the electronic device using the location data; and
correlate the travel of the electronic device to a calendar event and, if the travel indicates satisfaction of the calendar event, determine by inference that the calendar event is satisfied.

2. The portable electronic device of claim 1, wherein the travel that indicates satisfaction of the calendar event occurs within a predetermined period of time from a time associated with the calendar event.

3. The portable electronic device of claim 1, wherein the travel that indicates satisfaction of the calendar event occurs within a predetermined distance from a location associated with the calendar event.

4. The portable electronic device of claim 1, wherein the control circuit is further configured to mark the calendar event as complete when the inference that the calendar event is satisfied is made.

5. The portable electronic device of claim 1, wherein the control circuit is further configured to generate and transmit a message to another electronic device associated with a user that subscribes to share the calendar event to alert the user to completion of the calendar event.

6. The portable electronic device of claim 1, wherein travel that indicates satisfaction of the calendar event includes:
movement of the portable electronic device toward a location associated with the calendar event; and
a relative stop in motion of the portable electronic device at or near the location associated with the calendar event.

7. The portable electronic device of claim 6, wherein travel that indicates satisfaction of the calendar event further includes movement of the portable electronic device away from the location associated with the calendar event following the relative stop in motion.

8. A method of managing calendar events in a portable electronic device, comprising:
tracking travel of the electronic device;
correlating the travel of the electronic device to a calendar event; and
determining that the calendar event is complete if the travel indicates satisfaction of the calendar event.

9. The method of claim 8, wherein the travel that indicates satisfaction of the calendar event occurs within a predetermined period of time from a time associated with the calendar event.

10. The method of claim 8, wherein the travel that indicates satisfaction of the calendar event occurs within a predetermined distance from a location associated with the calendar event.

11. The method of claim 8, further comprising marking the calendar event as complete when the determination that the calendar event is complete is made.

12. The method of claim 8, further comprising generating and transmitting a message to another electronic device associated with a user that subscribes to share the calendar event to alert the user to completion of the calendar event.

13. The method of claim 8, wherein travel that indicates satisfaction of the calendar event includes:
movement of the portable electronic device toward a location associated with the calendar event; and
a relative stop in motion of the portable electronic device at or near the location associated with the calendar event.

14. The method of claim 13, wherein travel that indicates satisfaction of the calendar event further includes movement of the portable electronic device away from the location associated with the calendar event following the relative stop in motion.
